(19) United States
(12) Patent Application Publication
(10) Pub. No.: US 2018/0260695 A1
(43) Pub. Date: Sep. 13, 2018

(54) NEURAL NETWORK COMPRESSION VIA WEAK SUPERVISION

(71) Applicant: QUALCOMM Incorporated, San Diego, CA (US)

(72) Inventors: Somdeb MAJUMDAR, Mission Viejo, CA (US); Raghuraman KRISHNAMOORTHI, San Diego, CA (US)

(21) Appl. No.: 15/452,449

(22) Filed: Mar. 7, 2017

(51) Int. Cl. G06N 3/08

(52) U.S. Cl. CPC G06N 3/08

(57) ABSTRACT

A method, a computer-readable medium, and an apparatus for compressing a neural network with an unlabeled data set are provided. The apparatus may generate a first set of consecutive layers for the neural network. The first set of consecutive layers may share inputs with a second set of consecutive layers of the neural network. The apparatus may adjust weights associated with the first set of consecutive layers based on a function the difference between a first set of output values from the first set of consecutive layers and a second set of output values from the second set of consecutive layers in response to the unlabeled data set. The apparatus may remove the second set of consecutive layers from the neural network when the function of the difference between the first set of output values and the second set of output values satisfies a threshold.

### BACKGROUND

### Field

The present disclosure relates generally to machine learning, and more particularly, to neural network compression.

### Background

An artificial neural network, which may include an interconnected group of artificial neurons, may be a computational device or may represent a method to be performed by a computational device. Artificial neural networks may have corresponding structure and/or function in biological neural networks. However, artificial neural networks may provide useful computational techniques for certain applications in which conventional computational techniques may be cumbersome, impractical, or inadequate. Because artificial neural networks may infer a function from observations, such networks may be useful in applications where the complexity of the task or data makes the design of the function by conventional techniques burdensome.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

In any deep learning endeavors massive amounts of data are needed for the successful training of the model. However, a few large consumer-facing companies may own all of the data, while other companies may have little access to the data. For obvious reasons, the large consumer-facing companies that possess the data are unlikely to share the data with outside parties.

Running neural network algorithms efficiently on various hardware platforms may be desirable. However, to efficiently run deep learning algorithms on mobile or embedded devices, an original trained neural network may need to be compressed to meet the memory constraints and computing budgets of mobile or embedded devices. Access to the labeled training data set in order to compress the original trained neural network may be desirable. As the original trained neural network is compressed or pruned, the accuracy loss may be at least partially restored via fine tuning with the labeled training data set. Lack of access to the labeled training data set creates a problem for parties that want to run compressed deep learning algorithms on mobile or embedded devices, but don't have access to the labeled training data set to assist the compression of the original trained neural networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Large neural networks may need to be compressed to meet the memory constraints and computing budgets of mobile or embedded devices. Traditional methods may broadly perform pruning of a large neural network followed by fine-tuning on a labeled training data set. The ability to compress the large neural network to obtain a smaller neural network in the absence of a labeled training dataset may be desirable. In one configuration, the smaller neural network may mimic the performance of the large neural network as closely as possible

In an aspect of the disclosure, a method, a computer-readable medium, and an apparatus for compressing a neural network are provided. The apparatus may generate a first set of consecutive layers for the neural network. The first set of consecutive layers may share inputs with a second set of consecutive layers of the neural network. The apparatus may provide an unlabeled data set to the neural network. The apparatus may adjust weights associated with the first set of consecutive layers based on a function of the difference between a first set of output values from the first set of consecutive layers and a second set of output values from the second set of consecutive layers in response to the unlabeled data set. The apparatus may remove the second set of consecutive layers from the neural network when the function of the difference between the first set of output values and the second set of output values satisfies a threshold. The apparatus may remove the first set of consecutive layers from the neural network when the function of the difference between the first set of output values and the second set of output values does not satisfy the threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a neural network in accordance with aspects of the present disclosure.

FIG. 2 is a block diagram illustrating an exemplary deep convolutional network (DCN) in accordance with aspects of the present disclosure.

FIG. 3 is a diagram illustrating an example of compressing a trained neural network using an unlabeled data set.

FIG. 4 is a diagram illustrating an example of using backpropagation to train a student group to replace a teacher group within a neural network.

FIG. 5 is a flowchart of a method of compressing a trained neural network.

FIG. 6 is a conceptual data flow diagram illustrating the data flow between different means/components in an exemplary apparatus.

FIG. 7 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems for artificial neural networks will now be presented with reference to various apparatus and methods. The apparatus and methods will be described in the following detailed description and illustrated in the accompanying drawings by various blocks, components, circuits, processes, algorithms, etc. (collectively referred to as “elements”). The elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

An artificial neural network may be defined by three types of parameters: 1) the interconnection pattern between the different layers of neurons; 2) the learning process for updating the weights of the interconnections; and 3) the activation function that converts a neuron's weighted input to the neuron's output activation. Neural networks may be designed with a variety of connectivity patterns. In feed-forward networks, information is passed from lower layers to higher layers, with each neuron in a given layer communicating with neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

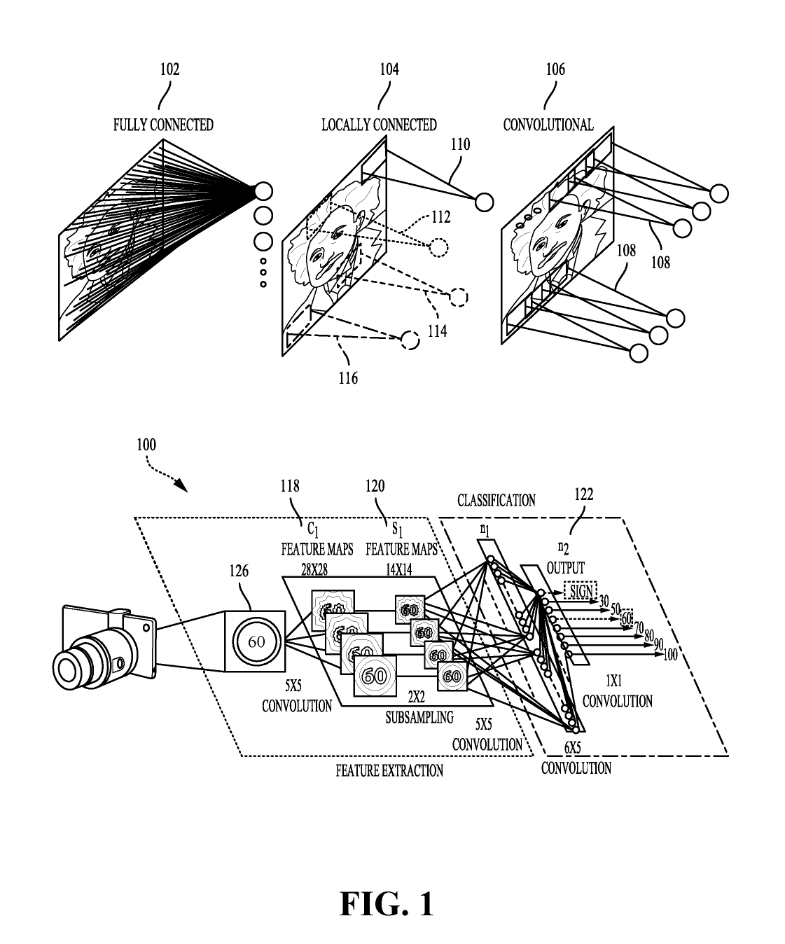

FIG. 1 is a diagram illustrating a neural network in accordance with aspects of the present disclosure. As shown in FIG. 1, the connections between layers of a neural network may be fully connected 102 or locally connected 104. In a fully connected network 102, a neuron in a first layer may communicate the neuron's output to every neuron in a second layer, so that each neuron in the second layer receives an input from every neuron in the first layer. Alternatively, in a locally connected network 104, a neuron in a first layer may be connected to a limited number of neurons in the second layer. A convolutional network 106 may be locally connected, and is further configured such that the connection strengths associated with the inputs for each neuron in the second layer are shared (e.g., connection strength 108). More generally, a locally connected layer of a network may be configured so that each neuron in a layer will have the same or a similar connectivity pattern, but with connections strengths that may have different values (e.g., 110, 112, 114, and 116). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a neural network 100 designed to recognize visual features from a car-mounted camera may develop high layer neurons with different properties depending on their association with the lower portion of the image versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be trained with supervised learning. During training, a DCN may be presented with an image, such as a cropped image of a speed limit sign 126, and a “forward pass” may then be computed to produce an output 122. The output 122 may be a vector of values corresponding to features such as “sign,” “60,” and “100.” The network designer may want the DCN to output a high score for some of the neurons in the output feature vector, for example the ones corresponding to “sign” and “60” as shown in the output 122 for a neural network 100 that has been trained. Before training, the output produced by the DCN is likely to be incorrect, and so an error may be calculated between the actual output of the DCN and the target output desired from the DCN. The weights of the DCN may then be adjusted so that the output scores of the DCN are more closely aligned with the target output.

To adjust the weights, a learning algorithm may compute a gradient vector for the weights. The gradient may indicate an amount that an error would increase or decrease if the weight were adjusted slightly. At the top layer, the gradient may correspond directly to the value of a weight associated with an interconnection connecting an activated neuron in the penultimate layer and a neuron in the output layer. In lower layers, the gradient may depend on the value of the weights and on the computed error gradients of the higher layers. The weights may then be adjusted so as to reduce the error. Such a manner of adjusting the weights may be referred to as “back propagation” as the manner of adjusting weights involves a “backward pass” through the neural network.

In practice, the error gradient for the weights may be calculated over a small number of examples, so that the calculated gradient approximates the true error gradient. Such an approximation method may be referred to as a stochastic gradient descent. The stochastic gradient descent may be repeated until the achievable error rate of the entire system has stopped decreasing or until the error rate has reached a target level.

After learning, the DCN may be presented with new images 126 and a forward pass through the network may yield an output 122 that may be considered an inference or a prediction of the DCN.

Deep convolutional networks (DCNs) are networks of convolutional networks, configured with additional pooling and normalization layers. DCNs may achieve state-of-the-art performance on many tasks. DCNs may be trained using supervised learning in which both the input and output targets are known for many exemplars The known input targets and output targets may be used to modify the weights of the network by use of gradient descent methods.

DCNs may be feed-forward networks. In addition, as described above, the connections from a neuron in a first layer of a DCN to a group of neurons in the next higher layer of the DCN are shared across the neurons in the first layer. The feed-forward and shared connections of DCNs may be exploited for fast processing. The computational burden of a DCN may be much less, for example, than that of a similarly sized neural network that includes recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered a three-dimensional network, with two spatial dimensions along the axes of the image and a third dimension capturing color information. The outputs of the convolutional connections may be considered to form a feature map in the subsequent layer 118 and 120, with each element of the feature map (e.g., 120) receiving input from a range of neurons in the previous layer (e.g., 118) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

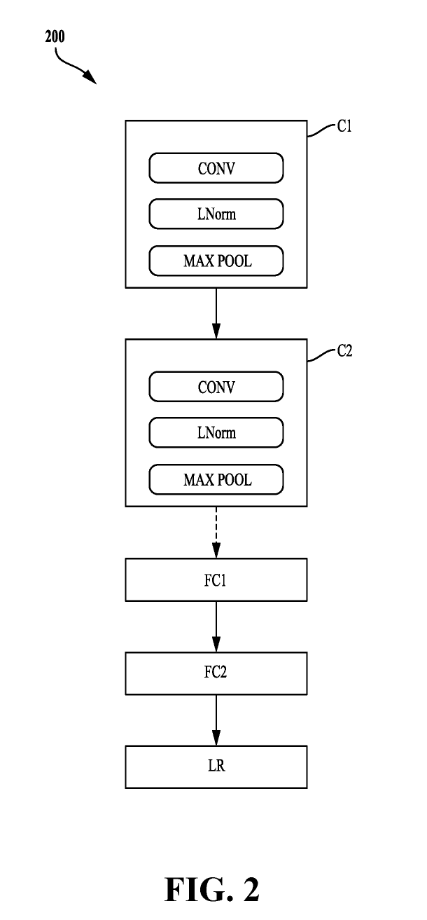

FIG. 2 is a block diagram illustrating an exemplary deep convolutional network 200. The deep convolutional network 200 may include multiple different types of layers based on connectivity and weight sharing. As shown in FIG. 2, the exemplary deep convolutional network 200 includes multiple convolution blocks (e.g., C1 and C2). Each of the convolution blocks may be configured with a convolution layer (CONV), a normalization layer (LNorm), and a pooling layer (MAX POOL). The convolution layers may include one or more convolutional filters, which may be applied to the input data to generate a feature map. Although two convolution blocks are shown, the present disclosure is not so limited, and instead, any number of convolutional blocks may be included in the deep convolutional network 200 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU or GPU of a system on a chip (SOC), optionally based on an Advanced RISC Machine (ARM) instruction set, to achieve high performance and low power consumption. In alternative embodiments, the parallel filter banks may be loaded on the DSP or an image signal processor (ISP) of an SOC. In addition, the DCN may access other processing blocks that may be present on the SOC, such as processing blocks dedicated to sensors and navigation.

The deep convolutional network 200 may also include one or more fully connected layers (e.g., FC1 and FC2). The deep convolutional network 200 may further include a logistic regression (LR) layer. Between each layer of the deep convolutional network 200 are weights (not shown) that may be updated. The output of each layer may serve as an input of a succeeding layer in the deep convolutional network 200 to learn hierarchical feature representations from input data (e.g., images, audio, video, sensor data and/or other input data) supplied at the first convolution block C1.

The neural network 100 or the deep convolutional network 200 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software component executed by a processor, or any combination thereof. The neural network 100 or the deep convolutional network 200 may be utilized in a large range of applications, such as image and pattern recognition, machine learning, motor control, and the like. Each neuron in the neural network 100 or the deep convolutional network 200 may be implemented as a neuron circuit.

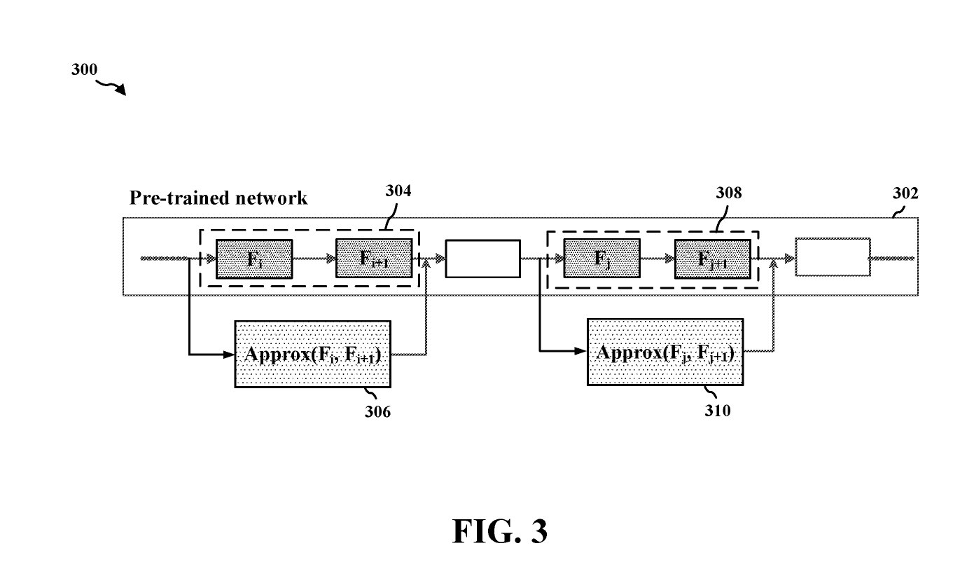

In certain aspects, the neural network 100 or the deep convolutional network 200 may be compressed by using an unlabeled data set. The operations performed to compress the neural network 100 or the deep convolutional network 200 will be described below with reference to FIGS. 3-7.

In one configuration, a smaller neural network may be trained on an unlabeled data set (i.e., in the absence of a labeled data set), where the smaller network is a subset of a larger pre-trained neural network. In one configuration, the smaller neural network may mimic the performance of the larger neural network as closely as possible. The above approach may be used, e.g., when a smaller neural network is deployed on devices targeting a different domain than the domain for which the larger network was trained.

FIG. 3 is a diagram illustrating an example of compressing a trained neural network 302 using an unlabeled data set. In one configuration, the trained neural network 302 may be compressed by reducing the number of network layers within the neural network 302. In one configuration, a labeled dataset may not be needed for compressing the neural network 302. In one configuration, even a similar looking dataset as the original labeled training data set may not be needed for compressing the neural network 302.

In the example, two groups of layers 304 and 308 may be identified within the trained neural network 302. Each group of layers (e.g., 304 or 308) may be referred to as a teacher group. Each teacher group (e.g., 304 or 308) may include two or more layers of the trained neural network 302. For example, the teacher group 304 may include layers Fᵢ and Fᵢ₊₁, and the teacher group 308 may include layers Fⱼ and Fⱼ₊₁.

For each teacher group, a smaller group made up of fewer parameters (e.g., fewer layers) may be created. The smaller group may be referred to as a student group. The student group may share the input with the corresponding teacher group. For example, for the teacher group 304, a student group 306 may be created. The student group 306 may have fewer parameters (e.g., fewer layers) than the teacher group 304. For example, the teacher group 304 may have two layers and the student group 306 may have one layer. The student group 306 may share the input with the teacher group 304. Similarly, for the teacher group 308, a student group 310 may be created. The student group 310 may have fewer parameters (e.g., fewer layers) than the teacher group 308. The student group 310 may share the input with the teacher group 308.

In one configuration, an input feature (e.g., a feature derived from unlabeled natural images) may be inserted at the beginning of a teacher group (e.g., the teacher group 304) and a student group (e.g., the student group 306). The outputs from the teacher group and the student group may be provided to a loss function, which may be based on the norm of the differences between the outputs from the teacher group and the student group. The weights associated with the student group may be adjusted by backpropagation using the loss function. In one configuration, the weights associated with a student group may be the weights of the interconnections that enter into the layers of the student group.

In one configuration, if the outputs from the teacher group and the outputs form the student group converge (e.g., on average, the norm of the difference between the outputs from the teacher group and the student group are less than a threshold), the teacher group may be replaced with the student group. Otherwise, the teacher group may be retained and the student group may be discarded. For example, and in one configuration, the threshold may be a predetermined value, such as 0.05.

In one configuration, each student group may be trained, fine-tuned, or evaluated with an unlabeled data set provided to the neural network 302. In one configuration, the compression may work locally, thus multiple locations (e.g., multiple groups of layers) in the neural network 302 may be compressed simultaneously. For example, the teacher groups 304 and 308 may be compressed simultaneously.

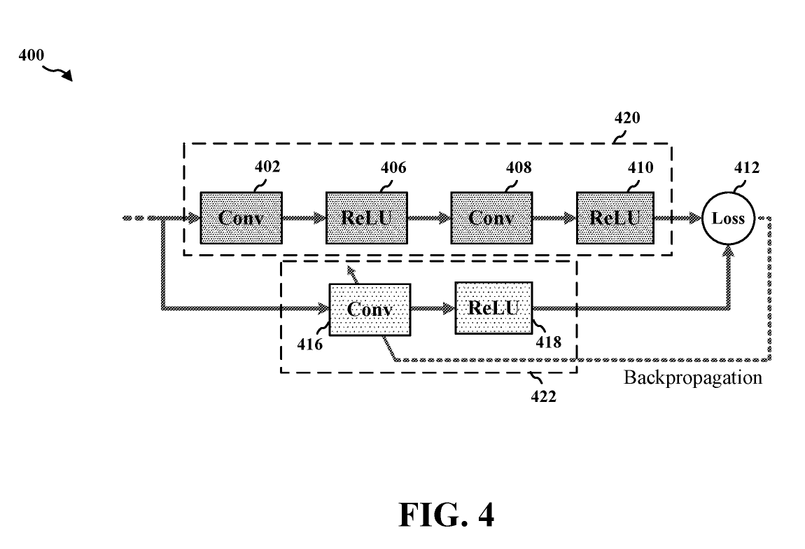

FIG. 4 is a diagram 400 illustrating an example of using backpropagation to train a student group 422 to replace a teacher group 420 within a neural network. In one configuration, the teacher group 420 may be the teacher group 304 or 308 described above with reference to FIG. 3, and the student group 422 may be the student group 306 or 310 described above, respectively. In the example, the teacher group 420 may include a convolutional layer 402, a rectified linear unit (ReLU) layer 406, a convolutional layer 408, and an ReLU layer 410. The student group 422 may include a convolutional layer 416 and an ReLU layer 418. Thus, the student group 422 may have few layers than the teacher group 420.

The student group 422 may share the input with the teacher group 420. In one configuration, an input feature (e.g., a feature derived from unlabeled natural images) may be inserted at the input of the teacher group 420 and the student group 422. The outputs from the teacher group 420 and the student group 422 may be provided to a loss function 412, which may be based on the norm of the differences between the outputs from the teacher group 420 and the student group 422. The weights (e.g., the weights associated with the convolutional layer 416) of the student group 422 may be adjusted by backpropagation using the loss function 412. In one configuration, the student group 422 may be trained using a small backpropagation comprising of only the extent of the teacher group 420. The backpropagation size is a subset of the entire network. Therefore, the training of the student group 422 may be faster compared to the training of the entire neural network.

In one configuration, the input for training the student group 422 may come from an unlabeled data set that looks similar in distribution to the original labeled training data set. In one configuration, the input for training the student group 422 may come from an unlabeled data set with random or synthetic data.

In one configuration, multiple student groups may be trained in parallel. Thus, multiple micro backpropagations may be performed in parallel. In one configuration, e.g., before deployment, a few serial training sessions (i.e., train the earliest student group first, then freeze the earliest student group, then train the next student group, etc.) may be performed.

Even though a convolutional neural network is described in the example, one of ordinary skill in the art would recognize that the method described above is not limited to the compression of a convolutional neural network. Instead, the method described above may be applied to compress any kind of neural network.

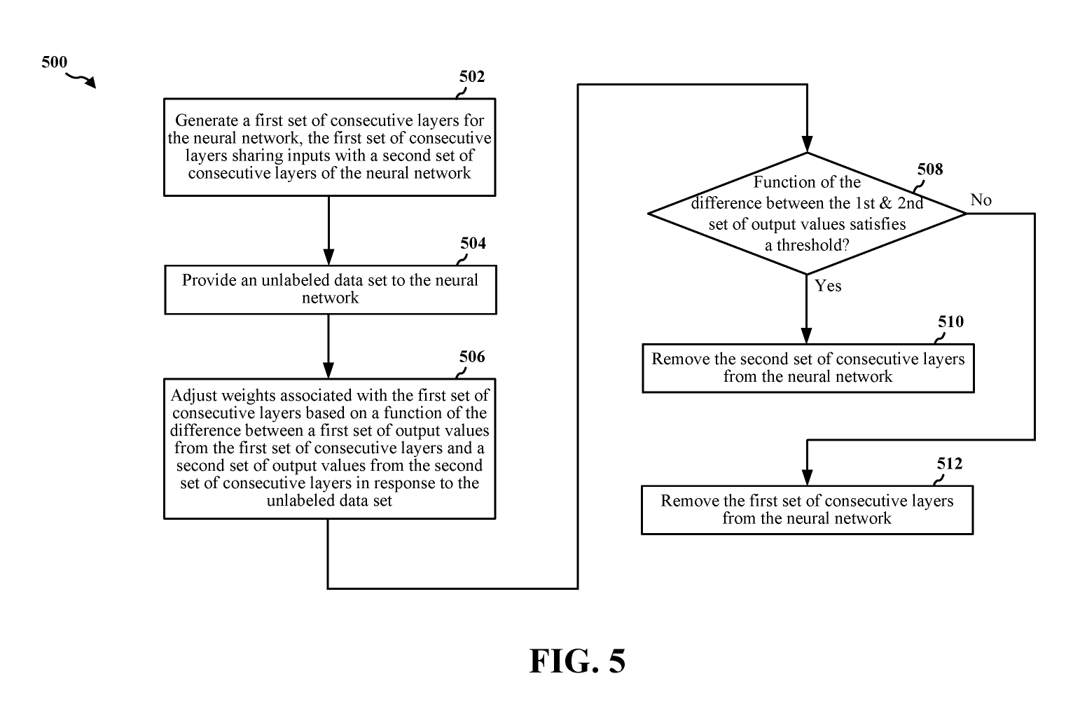

FIG. 5 is a flowchart 500 of a method of compressing a trained neural network (e.g., the neural network 302). In one configuration, the neural network may be a deep convolutional neural network (DCN). In one configuration, the neural network is trained using a labeled data set. The method may be performed by a computing device (e.g., the apparatus 602/602′).

At 502, the device may generate a first set of consecutive layers for the neural network. The first set of consecutive layers may share inputs with a second set of consecutive layers of the neural network. In one configuration, the first set of consecutive layers may be a student group (e.g., the student group 306, 310, or 422), and the second set of consecutive layers may be a teacher group associated with the student group (e.g., the teacher group 304, 308, or 420, respectively). In one configuration, the device may identify the second set of consecutive layers from the neural network before generating the first set of consecutive layers. The first set of consecutive layers may have fewer parameters (e.g., fewer layers) than the second set of consecutive layers. In one configuration, the device may generate the first set of consecutive layers arbitrarily.

At 504, the device may provide an unlabeled data set to the neural network. In one configuration, the unlabeled data set may have a distribution similar to the labeled data set that was used in training the neural network.

At 506, the device may adjust weights associated with the first set of consecutive layers based on a function of the difference between a first set of output values from the first set of consecutive layers and a second set of output values from the second set of consecutive layers in response to the unlabeled data set. In one configuration, the weights associated with the first set of consecutive layers may be the weights of interconnections that enter into the first set of consecutive layers. In one configuration, to adjust the weights associated with the first set of consecutive layers, the device may perform a backpropagation based on a loss function (e.g., the loss function 412) associated with the function of the difference between the first set of output values and the second set of output values. In one configuration, the function of the difference between the first set of output values and the second set of output values may be normalized for the loss function.

At 508, the device may determine whether the function of the difference between the first and second set of output values satisfies a threshold. For example, the device may determine whether the average difference between the first and second set of output values is less than the threshold. If the function of the difference between the first and second set of output values satisfies the threshold, the device may proceed to 510. If the function of the difference between the first and second set of output values does not satisfy the threshold, the device may proceed to 512.

At 510, the device may remove the second set of consecutive layers from the neural network. As a result, the second set of consecutive layers is replaced with the first set of consecutive layers, which is smaller and has fewer parameters (e.g., fewer layers) than the second set of consecutive layers.

At 512, the device may remove the first set of consecutive layers from the neural network. The second set consecutive layers may remain in the neural network.

In one configuration, the device may further generate a third set of consecutive layers for the neural network. The third set of consecutive layers may share inputs with a fourth set of consecutive layers of the neural network. The device may adjust a second set of weights associated with the third set of consecutive layers based on a second function of the difference between a third set of output values from the third set of consecutive layers and a fourth set of output values from the fourth set of consecutive layers in response to the unlabeled data set. The first set of consecutive layers and the third set of consecutive layers may be adjusted in parallel.

In one configuration, the first set of consecutive layers may precede the third set of consecutive layers in the neural network. The device may further adjust, after the second set of consecutive layers is removed from the neural network, the second set of weights associated with the third set of consecutive layers based on the second function of the difference between the third set of output values from the third set of consecutive layers and the fourth set of output values from the fourth set of consecutive layers in response to the unlabeled data set.

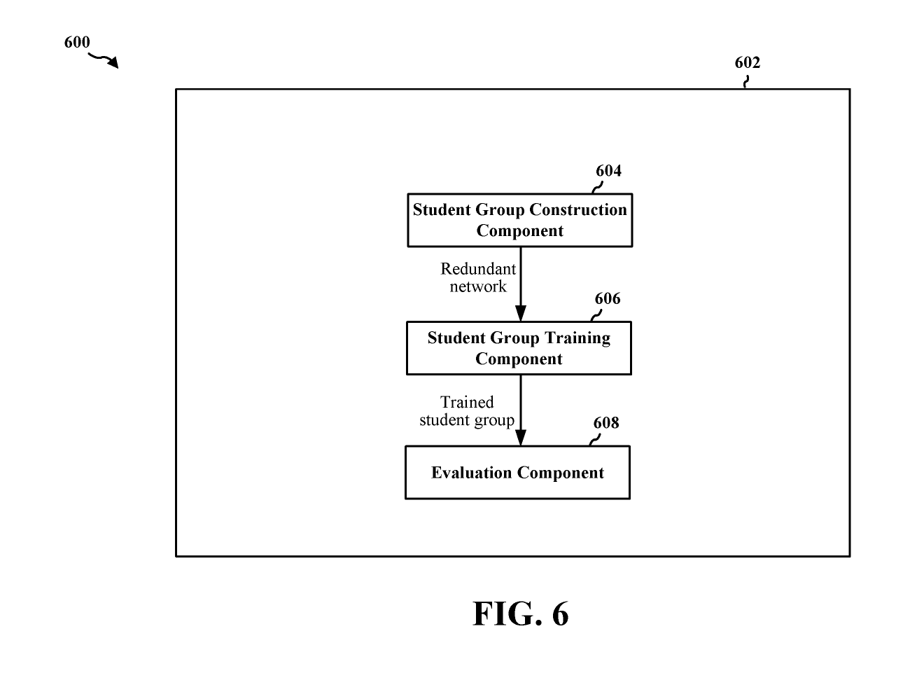

FIG. 6 is a conceptual data flow diagram 600 illustrating the data flow between different means/components in an exemplary apparatus 602. The apparatus 602 may be a computing device.

The apparatus 602 may include a student group construction component 604 that generates a student group to replace a teacher group. In one configuration, the student group construction component 604 may perform operations described above with reference to 502 in FIG. 5.

The apparatus 602 may include a student group training component 606 that receives a redundant network that has both the teacher group and student group sharing the same input from the student group construction component 604. The student group training component 606 may train the student group based on an unlabeled data set. In one configuration, the student group training component 606 may perform operations described above with reference to 506 in FIG. 5.

The apparatus 602 may include an evaluation component 608 that evaluates the performance of the trained student group based on the different between the outputs of the teacher group and the student group. The evaluation component 608 may further determine whether to replace the teacher group with the student group based on the evaluation. In one configuration, the evaluation component 608 may perform the operations described above with reference to 508, 510, or 512 in FIG. 5.

The apparatus 602 may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

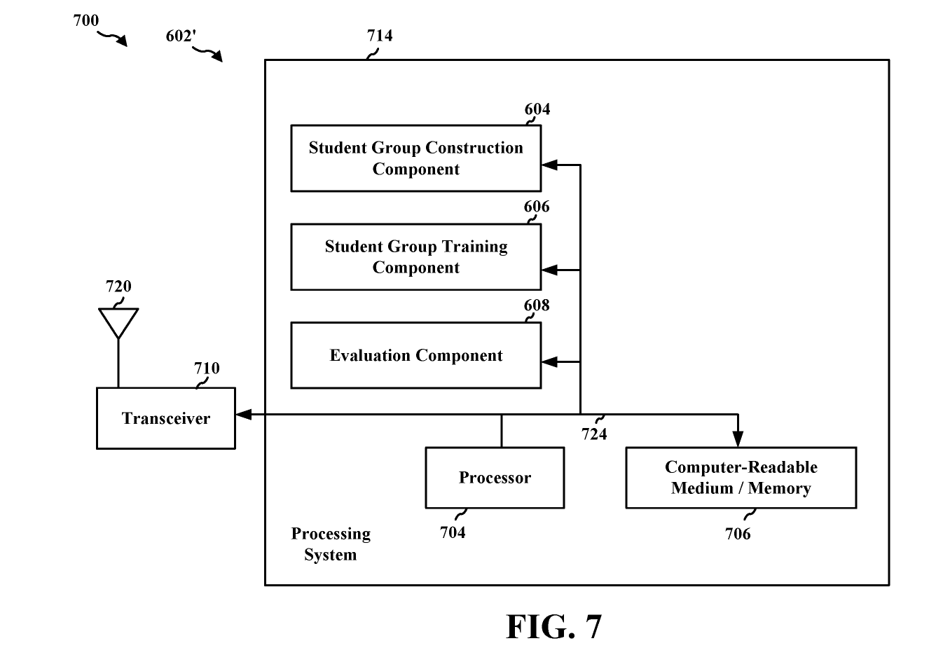

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware components, represented by the processor 704, the components 604, 606, 608, and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 may be coupled to one or more antennas 720. The transceiver 710 provides a means for communicating with various other apparatus over a transmission medium. The transceiver 710 receives a signal from the one or more antennas 720, extracts information from the received signal, and provides the extracted information to the processing system 714. In addition, the transceiver 710 receives information from the processing system 714, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system 714 further includes at least one of the components 604, 606, 608. The components may be software components running in the processor 704, resident/stored in the computer readable medium/memory 706, one or more hardware components coupled to the processor 704, or some combination thereof.

In one configuration, the apparatus 602/602′ may include means for generating a first set of consecutive layers for the neural network. In one configuration, the means for generating a first set of consecutive layers for the neural network may perform the operations described above with reference to 502 in FIG. 5. In one configuration, the means for generating a first set of consecutive layers for the neural network may include the student group construction component 604 and/or the processor 704.

In one configuration, the apparatus 602/602′ may include means for providing an unlabeled data set to the neural network. In one configuration, the means for providing an unlabeled data set to the neural network may perform the operations described above with reference to 504 in FIG. 5. In one configuration, the means for providing an unlabeled data set to the neural network may include the student group training component 606 and/or the processor 704.

In one configuration, the apparatus 602/602′ may include means for adjusting weights associated with the first set of consecutive layers based on a function of the difference between a first set of output values from the first set of consecutive layers and a second set of output values from the second set of consecutive layers in response to the unlabeled data set. In one configuration, the means for adjusting weights associated with the first set of consecutive layers may perform operations described above with reference to 506 in FIG. 5. In one configuration, the means for adjusting weights associated with the first set of consecutive layers may include the student group training component 606 and/or the processor 704. In one configuration, the means for adjusting the weights associated with the first set of consecutive layers may be configured to perform a backpropagation based on a loss function associated with the function of the difference between the first set of output values and the second set of output values.

In one configuration, the apparatus 602/602′ may include means for removing the second set of consecutive layers from the neural network when the function of the difference between the first set of output values and the second set of output values satisfies a threshold. In one configuration, the means for removing the second set of consecutive layers from the neural network may perform the operations described above with reference to 510 in FIG. 5. In one configuration, the means for removing the second set of consecutive layers from the neural network may include the evaluation component 608 and/or the processor 704.

In one configuration, the apparatus 602/602′ may include means for identifying the second set of consecutive layers from the neural network. In one configuration, the means for identifying the second set of consecutive layers from the neural network may include the student group construction component 604 and/or the processor 704.

In one configuration, the apparatus 602/602′ may include means for removing the first set of consecutive layers from the neural network when the function of the difference between the first set of output values and the second set of output values does not satisfy the threshold. In one configuration, the means for removing the first set of consecutive layers from the neural network may perform the operations described above with reference to 512 in FIG. 5. In one configuration, the means for removing the first set of consecutive layers from the neural network may include the evaluation component 608 and/or the processor 704.

In one configuration, the apparatus 602/602′ may include means for generating a third set of consecutive layers for the neural network. In one configuration, the means for generating a third set of consecutive layers for the neural network may include the student group construction component 604 and/or the processor 704.

In one configuration, the apparatus 602/602′ may include means for adjusting a second set of weights associated with the third set of consecutive layers based on a second function of the difference between a third set of output values from the third set of consecutive layers and a fourth set of output values from the fourth set of consecutive layers in response to the unlabeled data set. In one configuration, the means for adjusting the second set of weights associated with the third set of consecutive layers may include the student group training component 606 and/or the processor 704.

In one configuration, the apparatus 602/602′ may include means for adjusting, after the second set of consecutive layers is removed from the neural network, the second set of weights associated with the third set of consecutive layers based on the second function of the difference between the third set of output values from the third set of consecutive layers and the fourth set of output values from the fourth set of consecutive layers in response to the unlabeled data set. In one configuration, the means for adjusting, after the second set of consecutive layers is removed from the neural network, the second set of weights associated with the third set of consecutive layers may include the student group training component 606 and/or the processor 704.

The aforementioned means may be one or more of the aforementioned components of the apparatus 602 and/or the processing system 714 of the apparatus 602′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of compressing a neural network, comprising:
generating a first set of consecutive layers for the neural network, the first set of consecutive layers sharing inputs with a second set of consecutive layers of the neural network;
providing an unlabeled data set to the neural network;
adjusting weights associated with the first set of consecutive layers based on a function of a difference between a first set of output values from the first set of consecutive layers and a second set of output values from the second set of consecutive layers in response to the unlabeled data set; and
removing the second set of consecutive layers from the neural network when the function of the difference between the first set of output values and the second set of output values satisfies a threshold.

2. The method of claim 1, further comprising identifying the second set of consecutive layers from the neural network.

3. The method of claim 1, further comprising removing the first set of consecutive layers from the neural network when the function of the difference between the first set of output values and the second set of output values does not satisfy the threshold.

4. The method of claim 1, wherein the first set of consecutive layers has fewer parameters than the second set of consecutive layers.

5. The method of claim 1, wherein the neural network is trained with a labeled data set.

6. The method of claim 5, wherein the unlabeled data set has a distribution similar to the labeled data set.

7. The method of claim 1, wherein the adjusting the weights associated with the first set of consecutive layers comprises performing a backpropagation based on a loss function associated with the function of the difference between the first set of output values and the second set of output values.

8. The method of claim 7, wherein the function of the difference between the first set of output values and the second set of output values is normalized for the loss function.

9. The method of claim 1, further comprising:
generating a third set of consecutive layers for the neural network, the third set of consecutive layers sharing inputs with a fourth set of consecutive layers of the neural network; and
adjusting a second set of weights associated with the third set of consecutive layers based on a second function of a difference between a third set of output values from the third set of consecutive layers and a fourth set of output values from the fourth set of consecutive layers in response to the unlabeled data set, wherein the first set of consecutive layers and the third set of consecutive layers are adjusted in parallel.

10. The method of claim 9, wherein the first set of consecutive layers precedes the third set of consecutive layers in the neural network, wherein the method further comprises:
adjusting, after the second set of consecutive layers is removed from the neural network, the second set of weights associated with the third set of consecutive layers based on the second function of the difference between the third set of output values from the third set of consecutive layers and the fourth set of output values from the fourth set of consecutive layers in response to the unlabeled data set.

11. An apparatus for compressing a neural network, comprising:
means for generating a first set of consecutive layers for the neural network, the first set of consecutive layers sharing inputs with a second set of consecutive layers of the neural network;
means for providing an unlabeled data set to the neural network;
means for adjusting weights associated with the first set of consecutive layers based on a function of a difference between a first set of output values from the first set of consecutive layers and a second set of output values from the second set of consecutive layers in response to the unlabeled data set; and
means for removing the second set of consecutive layers from the neural network when the function of the difference between the first set of output values and the second set of output values satisfies a threshold.

12. The apparatus of claim 11, further comprising means for identifying the second set of consecutive layers from the neural network.

13. The apparatus of claim 11, further comprising means for removing the first set of consecutive layers from the neural network when the function of the difference between the first set of output values and the second set of output values does not satisfy the threshold.

14. The apparatus of claim 11, wherein the first set of consecutive layers has fewer parameters than the second set of consecutive layers.

15. The apparatus of claim 11, wherein the neural network is trained with a labeled data set, wherein the unlabeled data set has a distribution similar to the labeled data set.

16. The apparatus of claim 11, wherein the means for adjusting the weights associated with the first set of consecutive layers is configured to perform a backpropagation based on a loss function associated with the function of the difference between the first set of output values and the second set of output values.

17. The apparatus of claim 16, wherein the function of the difference between the first set of output values and the second set of output values is normalized for the loss function.

18. The apparatus of claim 11, further comprising:
means for generating a third set of consecutive layers for the neural network, the third set of consecutive layers sharing inputs with a fourth set of consecutive layers of the neural network; and
means for adjusting a second set of weights associated with the third set of consecutive layers based on a second function of a difference between a third set of output values from the third set of consecutive layers and a fourth set of output values from the fourth set of consecutive layers in response to the unlabeled data set, wherein the first set of consecutive layers and the third set of consecutive layers are adjusted in parallel.

19. The apparatus of claim 18, wherein the first set of consecutive layers precedes the third set of consecutive layers in the neural network, wherein the apparatus further comprises:
means for adjusting, after the second set of consecutive layers is removed from the neural network, the second set of weights associated with the third set of consecutive layers based on the second function of the difference between the third set of output values from the third set of consecutive layers and the fourth set of output values from the fourth set of consecutive layers in response to the unlabeled data set.

20. An apparatus for compressing a neural network, comprising:
a memory; and
at least one processor coupled to the memory and configured to:
generate a first set of consecutive layers for the neural network, the first set of consecutive layers sharing inputs with a second set of consecutive layers of the neural network;
provide an unlabeled data set to the neural network;
adjust weights associated with the first set of consecutive layers based on a function of a difference between a first set of output values from the first set of consecutive layers and a second set of output values from the second set of consecutive layers in response to the unlabeled data set; and
remove the second set of consecutive layers from the neural network when the function of the difference between the first set of output values and the second set of output values satisfies a threshold.

21. The apparatus of claim 20, wherein the at least one processor is further configured to identify the second set of consecutive layers from the neural network.

22. The apparatus of claim 20, wherein the at least one processor is further configured to remove the first set of consecutive layers from the neural network when the function of the difference between the first set of output values and the second set of output values does not satisfy the threshold.

23. The apparatus of claim 20, wherein the first set of consecutive layers has fewer parameters than the second set of consecutive layers.

24. The apparatus of claim 20, wherein the neural network is trained with a labeled data set.

25. The apparatus of claim 24, wherein the unlabeled data set has a distribution similar to the labeled data set.

26. The apparatus of claim 20, wherein, to adjust the weights associated with the first set of consecutive layers, the at least one processor is configured to perform a backpropagation based on a loss function associated with the function of the difference between the first set of output values and the second set of output values.

27. The apparatus of claim 26, wherein the function of the difference between the first set of output values and the second set of output values is normalized for the loss function.

28. The apparatus of claim 20, wherein the at least one processor is further configured to:
generate a third set of consecutive layers for the neural network, the third set of consecutive layers sharing inputs with a fourth set of consecutive layers of the neural network; and
adjust a second set of weights associated with the third set of consecutive layers based on a second function of a difference between a third set of output values from the third set of consecutive layers and a fourth set of output values from the fourth set of consecutive layers in response to the unlabeled data set, wherein the first set of consecutive layers and the third set of consecutive layers are adjusted in parallel.

29. The apparatus of claim 28, wherein the first set of consecutive layers precedes the third set of consecutive layers in the neural network, wherein the at least one processor is further configured to:
adjust, after the second set of consecutive layers is removed from the neural network, the second set of weights associated with the third set of consecutive layers based on the second function of the difference between the third set of output values from the third set of consecutive layers and the fourth set of output values from the fourth set of consecutive layers in response to the unlabeled data set.

30. A computer-readable medium storing computer executable code, comprising code to:
generate a first set of consecutive layers for a neural network, the first set of consecutive layers sharing inputs with a second set of consecutive layers of the neural network;
provide an unlabeled data set to the neural network;
adjust weights associated with the first set of consecutive layers based on a function of a difference between a first set of output values from the first set of consecutive layers and a second set of output values from the second set of consecutive layers in response to the unlabeled data set; and
remove the second set of consecutive layers from the neural network when the function of the difference between the first set of output values and the second set of output values satisfies a threshold.
